(19) United States
(12) Patent Application Publication
(10) Pub. No.: US 2004/0007317 A1
(43) Pub. Date: Jan. 15, 2004

(54) Applying a hot melt band to paper sheet covering

(76) Inventor: Chia-Hsiung Wu, Taipei (TW)

Correspondence Address: Chia-Hsiung Wu, P.O. Box No.6-57, Chung-Ho, Taipei, 235, TW

(21) Appl. No.: 10/193,198

(22) Filed: Jul. 12, 2002

(51) Int. Cl. B32B 31/00

(52) U.S. Cl. 156/212; 156/475

(57) ABSTRACT

A hot melt band of the present invention provided for covering paper sheets mainly includes a main body of a hot melt band in a strap shape, an upper positive and a lower negative sides coated with a layer of adhesive film and a topmost surface isolated by a sheet of isolating paper to be freely applied to any kind of cover paper so as to achieve an application state of multiple enhancements.

### BACKGROUND OF THE INVENTION

1) Field of the Invention

The present invention relates to applying a hot melt band to paper sheet covering, more especially to an application state of using a hot melt band to cover stacked paper sheets into a book-like format; the special mono-structure facilitates applying any kind of paper to achieve the objective of free covering.

2) Description of the Prior Art

Previously, methods of covering stacked paper sheets into a book usually coat a layer of adhesive glue onto the cover edge side, then directly affix a cover to finish the book binding. That method has been consistently adopted by regular publishers. Recently, in order to meet the requirement of the information development and collection, some stationary factories use card paper material for covering the files collected in business environment. That card paper material is in a long strap shape and regulated by the brand manufacturer. Normally, it is provided to be used for A4 paper and only has material sized for A4 width and length; all the other sizes are counted as special regulations. Furthermore, the covering of thereof requires an exclusive hot melt machine for processing to achieve the objective of adhering the cover ends. Therefore, not only paper sheets are subjected to getting loose during the operation, the dimensions thereof are regulated by the brand manufacturers and not flexible for free application, furthermore, the material selection is limited by the brand manufactures as well.

FIGS. 1 to 3 show the recent methods of using card paper for covering; referring to FIG. 1, the cover edge side (11) of the paper sheets (1) is placed opposite a paper type material (10) for covering; the paper type material (10) is a long strap of card paper with two parallel pre-folded lines (12) disposed at the center of the breadth thereof; the top surface of the cover back side (14) defined by two opposite pre-folded lines (12) is coated with a layer of hot melt adhesive (13).

Referring to FIG. 2, after the paper sheets (1) are laid opposite the paper type material (10), the layer of hot melt adhesive (13) on the cover back side (14) aligns with one end of the paper sheets (1). The existence of the pre-folded lines (12) makes the paper type material (10) easy to bend into an n-shape for insertion onto the paper sheets (1); after the insertion, it is placed into an exclusive hot melt machine (2), as shown in FIG. 3; the hot melt machine (2) comprises a machine table (21) with a hot iron press block (22) of electrical heat effect disposed at the upper aspect thereof; a handle bar (23) connects the hot iron press block (22) and a press ingot (24) to form a link; operating the handle bar (3) makes the press ingot (24) press one end of the paper sheets (1); the hot iron press block (22) generates hot temperature to produce hot melt effect on the layer of hot melt adhesive (13) at one end of the paper type material (10) such that the glue body on the layer of hot melt adhesive (13) melts into the lateral ends of the paper sheets (1) to achieve the covering objective; the function of the press ingot (24) is to temporarily fix the sheets of paper.

However, the application of the abovementioned method has many shortcomings. For example, the paper type material (10) is manufactured by the brand factories and the regulation thereof is focus on the mostly used A4 paper size; that limits the length of the paper type material (10). For other dimensional sizes, it is necessary to cut the paper type material (10) into different lengths. Furthermore, the widths of the cover back sides (14) are also regulated by the brand factories. For example, between 3 to 15 mm, there are thirteen different thickness regulations. Therefore, the user has to prepare material in various dimensions. That is very complicated. Additionally, the colors of the specific paper type material (10) are also regulated by the brand factories and fail to be flexible for selection. Furthermore, the price of that type of material is usually higher and the material is decided by the brand factory thereby unable to be flexible for selection. In addition, since the layer of hot melt adhesive (13) has no temporary adhesive effect, the sheets of paper are subjected to getting loose during the covering operation.

Furthermore, the possibility of having a plurality of unused pre-folded lines (12) left on the paper type material (10) affects the external appearance thereof; the paper type material (10), referred as paper type usually, is a main body of a long strap so it is necessary to use other sheets of paper with wider width for covering a book; therefore, the shortcoming of the paper type material (10) is not capable of fulfilling a free application purpose.

Therefore, the present invention provides an independent hot melt band with temporary adhesive effect to be applied extensively to adhering or binding any paper or fabric and capable of temporarily fixing the paper sheets.

### SUMMARY OF THE INVENTION

The objective of the present invention is to provide a special hot melt band for covering the paper sheets; the holt melt band is in a mono-strap shape with a normal temperature adhesive effect for facilitating covering operation so as to temporarily fixing paper sheets; its mono unit is flexible for being applied to any type of paper to fulfill the extensively beautifying objective of covering so as to facilitating the adoption of any format.

The implementation of the present invention utilizes a main body of a hot melt band capable of taking hot temperature; the positive and the negative sides thereof are coated with a layer of normal temperature adhesive film for providing temporary fixing application; the topmost surface has a sheet of isolating paper for facilitating isolation and storage. The layer of adhesive film temporarily positions the cover edge ends of the paper sheets to prevent the loosening situation and is able to be extensively applied to any cover paper material; that is the primary objective of the present invention.

Another objective of the present invention is to provide the hot melt band rolled into a coil to facilitate storage.

Yet another objective of the present invention is to focus on using the cover paper for any personal covering application; through the regulation of a pre-folded line sector, the present invention is suitable to be used by people of any levels and ages; the pre-folded line sector mainly comprises a main body in a shape of a flat plate, one side thereof extends from a guide post to define and guide a slide ruler which is capable of displacing in parallel opposite the main body; the displacement interval formed between the slide ruler and the main body is relatively the thickness of the paper sheets and is used to obtain a specific pre-folded line.

Still another objective of the present invention is to have a holding rod disposed on one side of the pre-folded line sector opposite the slide ruler for holding the paper sheets.

Another objective of the present invention is to have a lock button disposed at the position on the pre-folded line sector opposite the handle grip for locking the slide ruler.

To enable a further understanding of the structural features and the technical contents of the present invention, the brief description of the drawings below is followed by the detailed description of the preferred embodiment.

### BRIEF DESCRIPTION OF THE DRAWINGS

FIG. 1 is a drawing of applying a conventional method using a paper type material for covering.

FIG. 2 is a schematic drawing of the conventional covering procedure.

FIG. 3 is a schematic drawing of the conventional covering method using a hot melt machine for processing.

FIG. 4 is a pictorial and schematic drawing of the present invention.

FIG. 5 is a structural drawing of the detail structure of a hot melt band of the present invention.

FIG. 6 is a pre-operational drawing of the implementation of the hot melt band of the present invention.

FIG. 7 is a drawing of the implementation of the present invention.

FIG. 8 is a schematic drawing of another application of the present invention.

FIG. 9 is the first schematic drawing of the covering procedure of the present invention.

FIG. 10 is the second schematic drawing of the covering procedure of the present invention.

FIG. 11 is a schematic drawing of the covering effect of the present invention.

FIG. 12 is a schematic drawing of the covering, hot melt processing and tool application of the present invention.

FIG. 13 is a pictorial drawing of a pre-folded line sector of the present invention.

FIG. 14 is a schematic drawing of the application procedure of the pre-folded line sector of the present invention.

FIG. 15 is the first schematic drawing of applying the pre-folded line sector of the present invention.

FIG. 16 is the second schematic drawing of the application procedure of the pre-folded line sector of the present invention.

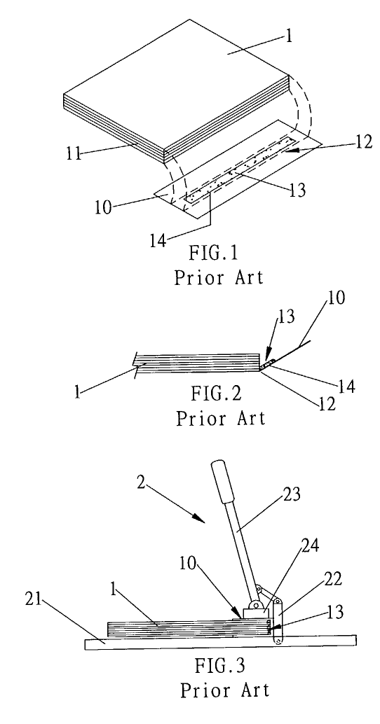

### DETAILED DESCRIPTION OF THE PREFERRED EMBODIMENTS

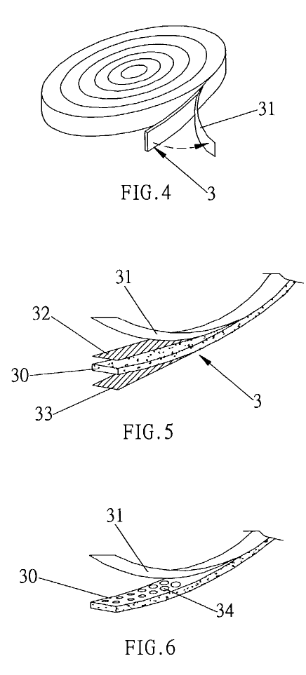

Referring to FIG. 4, a hot melt band (3) of the present invention is coiled into a roll and isolated by a sheet of isolating paper (31).

Referring to FIG. 5, the hot melt band (3) of the present invention mainly has a adhesive hot melt band main body (30) formed through hot melt effect; the positive and the negative sides thereof are respectively disposed with a layer of normal temperature adhesive film (32, 33) and topped by a sheet of isolating paper (31); before application, as shown in FIG. 6, the sheet of isolating paper (31) on the upper aspect at a free end is detached to allow the hot melt band (30) locate on any paper to achieve the installation objective.

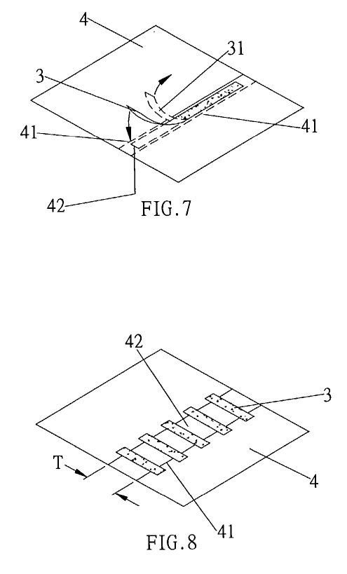

Referring to FIGS. 7 and 8, the hot melt band (3) of the present invention is applied directly to the upper aspect of a cover paper (4) made of any material; on the cover paper (4), a pre-folded line (41) is marked by any method at the position relative to the covering; a cover back side (42) is formed between two opposite pre-folded lines (41) and the top surface thereof is directly adhered with the hot melt band (3); after the isolating paper (31) is peeled off, the top surface of the hot melt band (3) forms a temporary adhesive effect.

As shown in FIG. 8, the relative distance between the two pre-folded lines (41) on the cover paper (4) varies according to the variable thickness (T) of the covering thereby making the breadth of the cover back side (42) different. Therefore, the hot melt band (3) can be horizontally disposed to flexibly adapt to various covering thickness (T) or patched in parallel to increase the breadth.

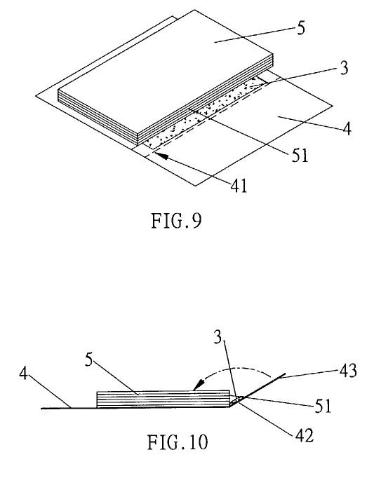

Referring to FIG. 9, after the hot melt band (3) is adhered on the cover paper (4) according to the steps indicated in FIG. 7, the paper sheets (5) are placed opposite the corner positions of the pre-folded lines (41) to make the cover edge end (51) align flush to the front side of the hot melt band (3).

Referring to FIG. 10, the cover back side (42) covers the paper sheets (5) to make the cover (43) able to cover completely and the hot melt band (3) align with the cover edge end (51) of the paper sheets (5).

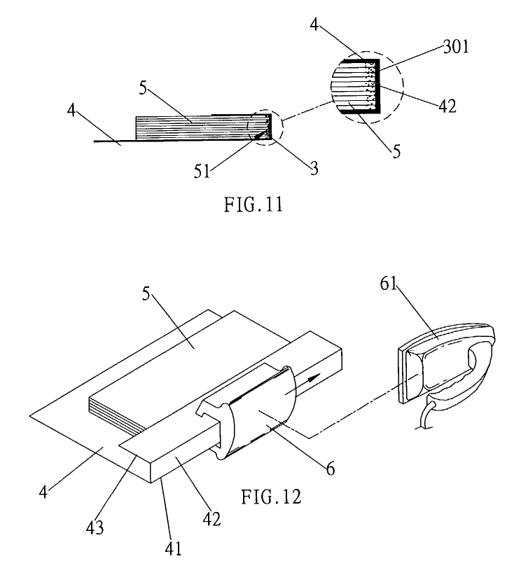

Referring to FIG. 11, the finished covering as shown in FIG. 10, the front side of the hot melt band (3) aligns with the cover edge end (51) of the paper sheets (5); since the front side of the hot melt band (3) has a layer of normal temperature adhesive film (32), it is able to temporarily fix and adhere the entire cover edge end (51) of the paper sheets (5) at a normal temperature; the adhesion prevents the paper sheets (5) from getting loose; furthermore, the melt adhesive (301) formed by the hot melt band (3) under heat penetrates into the seams between the stacked sheets of paper; in addition, the melt adhesive (301) relatively causes hot-melt and adhesive effect to the cover back side (42) so as to e accomplish the covering objective.

FIG. 12 shows the application method of the hot melt process. Since the hot melt band (3) has a temporary fixing effect, a hot iron device (6) or a regular iron (61) can be used to conduct heating and pressing process toward the cover back side (42) extended from the cover paper (4). Through the inwardly heating procedure of the hot iron device (6), the hot melt adhesive (301) therein obtains the spreading effect; furthermore, the hot iron device (6) forms a breadthwise pressure and clamping force toward the covering paper on the upper and lower sides to make the pre-folded lines (41) form obviously.

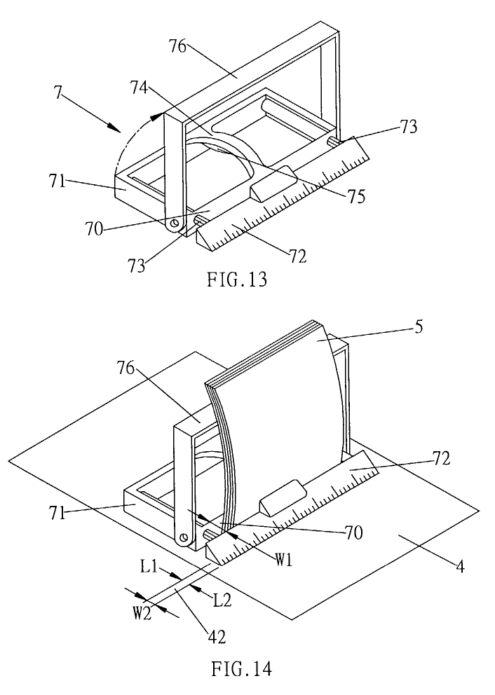

FIG. 13, since the main body (30) of the hot melt band (3) is an independent mono-body, it is able to affix and adapt to any selected paper used for the cover or the covering purpose. The pre-folded line (41) can be formed by using any sector or a pointed object, such as a blunt knife to mark a line of rupture and that is the pre-folded line (41).

A pre-folded line sector (7), as shown in FIG. 13, can be used to facilitate the obtaining of the pre-folded line (41); the pre-folded line sector (7) has a main body (71) in a flat plate shape; a guide post (73) provides a sliding ruler (72) for making parallel and relative displacement. A handle grip (74) is disposed on the main body (71) and a lock button (75) is disposed at the position opposite the handle grip (74); the lock button (75) locks the displacement position of the sliding ruler (72). A holding rod (76) is disposed on the main body (71) and aligns flush with a control side (70).

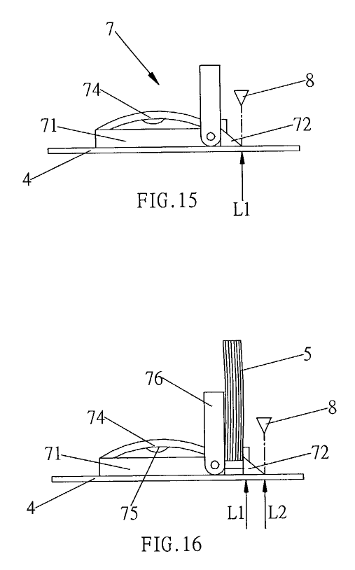

FIGS. 14, 15 and 16 show the application of the pre-folded line sector (7). In order to obtain two parallel pre-folded lines (41) on the width of the interior of the cover paper (4), the pre-folded line sector (7) is placed opposite the desired pre-folded line (41), as shown in FIG. 15. Then a blunt knife (8) marks a first pre-folded line (L1) along a slide ruler (72); when in operation, the user holds the handle grip (74) to keep the re-folded line sector (7) on the top surface of the cover paper (4) allowing the main body (71) to effectively locate on the upper aspect of the cover paper (4). After the blunt knife (8) obtains the first pre-folded line (L1), the slide ruler (72) is pulled outwardly; then the paper sheets (5) is placed between the inner receiving plane of the slide ruler (72) and the opposite control side (70) of the main body (71); the slide ruler (72) pushes inwardly to press the paper sheets (5) thereby forming a width distance (W1) between the control side (70) and the inner side of the slide ruler (72); the width distance (W1) is the thickness of the paper sheets (5). After that, again the blunt knife (8) is used to mark a second pre-folded line (L2); obviously, a width (W2) relative to the pre-folded line (41) is obtained according to the thickness of the paper sheets (5), as shown in FIG. 14; in addition, specific and corresponding pre-folded lines (L1, L2) as well as the width of the cover back side (42) are precisely obtained. After using the pre-folded line sector (7) to obtain the pre-folded lines (41), the hot melt band (3) is laid thereon in the way shown in FIGS. 7 and 8; after the isolating paper (31) is peeled off, as indicated in FIG. 7, the covering operation starts, as shown in FIG. 11, to make the hot melt band (3) temporarily adhere to the cover edge end (51) of the paper sheets (5) to prevent the sheets of paper from getting loose; an efficient covering and adhesion is therefore achieved through the hot melt procedure shown in FIG. 12.

In addition to have a long strap-shaped hot melt band (3), as shown in FIG. 4, punch holes (34) in any shapes, open slots or through holes made in any method are disposed on the inner side of the main body (30) of the hot melt band (3), as shown in FIG. 6, to allow the main body (30) of the hot melt band (3) of same unit material volume to have higher thickness; furthermore, during the hot melting procedure, though the vacant positions of the punch holes (34), the adhesive substance on the main body (30) obtains more flow space without resistant pressure thereby facilitating the spreading and distribution of the melt adhesive (301) and obtaining preferred pressing and spreading dynamic energy to effectively fill in all the seams and increase the adhesive attachment.

The present invention of a hot melt band application effect of covering a paper sheets has the following advantages:

1. During the binding, the length of the cover is determined flexibly without any limiting factor; therefore, the present invention is capable of conveniently adapting to paper sheets in any regulations and with any side lengths.

2. The application of the present invention is not limited by the thickness of the cover back side and is clear for corresponding functionality.

3. The hot melt band has temporary adhesive effect for preventing the stacked sheets of paper from getting loose during the covering procedure.

4. The application is not limited by the material of the paper; paper of any material, such as fiber paper, sticky paper or textile paper capable of being hot melt and adhered are usable; therefore, the material for the corresponding cover paper is optional and relatively, the color thereof is also optional so as to achieve a beautiful covering.

5. Paper in any area size can be directly used for the cover; for example, the embodiment of the present invention directly uses a wide sheet of paper and freely obtains pre-folded lines on the inner side thereof to lay the hot melt band so as to achieve the objective of using paper in any area size, relatively adopting the cover paper of any material or even utilizing the color paper available on the market for the covering the edges.

It is of course to be understood that the embodiment described herein is merely illustrative of the principles of the invention and that a wide variety of modifications thereto may be effected by persons skilled in the art without departing from the spirit and scope of the invention as set forth in the following claims.

1. The present invention of applying a hot melt band to paper sheets covering, more especially a hot melt band application state provided for paper sheets in any regulation and adopting any paper for covering, is mainly characterized that a melt adhesive main body is capable of taking hot temperature effect, an upper positive and a lower negative sides are coated with a layer of normal temperature adhesive film and a side is isolated by a sheet of isolating paper.

2. The present invention of applying a hot melt band for paper sheets covering according to claim 1, wherein the width of the band body is punched with punch holes in any shape.

3. The present invention of applying a hot melt band to cover a paper sheets according to claim 1, wherein the hot melt band is rolled into a coil.

4. A sector for obtaining a pre-folded line mainly comprises a main body in a shape of a flat plate with one control side thereof disposed with a slide ruler sliding in parallel via a guide post for making relative movement.

5. The sector for obtaining a pre-folded line according to claim 4, wherein a holding rod is disposed at the position on the control side.

6. A sector for obtaining a pre-folded line according to claim 4, wherein a lock button of the slide ruler is disposed at a relative position of a handle grip on the main body.
